(19) United States
(12) Patent Application Publication
(10) Pub. No.: US 2026/0186304 A1
(43) Pub. Date: Jul. 2, 2026

(54) OPTICAL DEVICE, VIRTUAL IMAGE DISPLAY APPARATUS, AND HEAD-MOUNTED DISPLAY

(71) Applicant: SONY GROUP CORPORATION, Tokyo (JP)

(72) Inventors: Hideki ONO, Tokyo (JP); Yui ISHII, Kanagawa (JP); Yuri NAKAMURA, Kanagawa (JP); Nobuyuki SUZUKI, Tokyo (JP); Christophe PEROZ, Tokyo (JP)

(73) Assignee: SONY GROUP CORPORATION, Tokyo (JP)

(21) Appl. No.: 19/130,271

(22) PCT Filed: Nov. 15, 2023
(86) PCT No.: PCT/JP2023/041016

§ 371 Date: May 15, 2025

(30) Foreign Application Priority Data
Nov. 30, 2022 (JP) 2022-191884

(51) Int. Cl. G02B 27/01; G02B 27/42

(52) U.S. Cl. CPC G02B 27/0172; G02B 27/4272; G02B 2027/0114; G02B 2027/0136

(57) ABSTRACT

It is a main object to provide an optical device that suppresses deterioration of light amount balance between RGB of an output display image with respect to input image information when used in a see-through display or the like, and makes it difficult for the color tone to change. An optical device according to the present technology includes: a first light guide plate having a first light guide path formed of a first material; and a second light guide plate having a second light guide path formed of a second material different from the first material, in which the second material has a higher light transmittance than the first material.

### TECHNICAL FIELD

The present technology relates to an optical device including two or more types of light guide plates having light guide paths formed of different materials, a virtual image display apparatus including the optical device, and a head-mounted display including the virtual image display apparatus.

### BACKGROUND ART

Conventionally, a virtual image display apparatus that transmits image information formed by an image forming section through light guide paths of an optical device and provides the image information as an enlarged virtual image and is used for a head-mounted display as an eyewear or a see-through display used for a show window, etc. is known.

For example, Patent Literature 1 below has disclosed an optical device in which a plurality of in-coupling optical elements selectively deflects particular wavelengths of light, such that the light propagates through waveguides different for each particular wavelength.

### CITATION LIST

### Patent Literature

Patent Literature 1: Japanese Unexamined Patent Application Publication No. 2021-519445

### DISCLOSURE OF INVENTION

### Technical Problem

However, some materials that form the light guide paths significantly absorb light of a shorter wavelength range. Therefore, the color tone may change due to deterioration of light amount balance between RGB. For example, an output display image may appear more yellow than input image information. In a case where the color tone of the output display image has changed, it is necessary to perform a control, e.g., to increase the input of light of a shorter wavelength range in consideration of light absorption by the material. It can contribute to a cost increase of the apparatus.

The present technology has been made in view of such circumstances. It is a main object of the present technology to provide an optical device that suppresses deterioration of light amount balance between RGB of an output display image with respect to input image information when used in a see-through display or the like, and makes it difficult for the color tone to change.

### Solution to Problem

An optical device according to the present technology includes: a first light guide plate having a first light guide path formed of a first material; and a second light guide plate having a second light guide path formed of a second material different from the first material, in which the second material has a higher light transmittance than the first material.

Here, “having a higher light transmittance” means, in particular, having a relatively high transmittance for light with a shorter wavelength, for example, having a relatively high transmittance for a wavelength of 493 nm or less corresponding to an upper limit wavelength of blue light.

Moreover, a virtual image display apparatus including the optical device according to the present technology includes: an image forming section that outputs image light; and an optical lens that converts the image light output from the image forming section into parallel light, and can take a configuration to cause the parallel light to enter the light guide plate of the optical device according to the present technology.

In addition, the virtual image display apparatus including the optical device according to the present technology can be widely used for general applications of the see-through display, e.g., a head-mounted display and a show window.

### BRIEF DESCRIPTION OF DRAWINGS

FIG. 1 Side cross-sectional views and plan views showing configuration examples of an optical device according to the present technology.

FIG. 2 A schematic view showing a configuration example of a virtual image display apparatus according to the present technology.

FIG. 3 Schematic views showing shape examples of a diffraction grating that can be used for the optical device according to the present technology.

FIG. 4 Views showing arrangement examples of optical components of the optical device according to the present technology.

FIG. 5 Views showing arrangement examples of a protective substrate in the optical device according to the present technology.

FIG. 6 A schematic view showing a modified example of the virtual image display apparatus according to the present technology.

FIG. 7 A schematic view showing a modified example of the virtual image display apparatus according to the present technology.

FIG. 8 A schematic view showing a modified example of the virtual image display apparatus according to the present technology.

FIG. 9 A schematic view showing a modified example of the virtual image display apparatus according to the present technology.

FIG. 10 A conceptual diagram showing a mounting example of a head-mounted display according to the present technology.

FIG. 11 A graph showing relationships between refractive index and wavelength dispersion of two kinds of materials that can be used for the optical device.

FIG. 12 A graph showing relationships between light transmittance and wavelength dispersion of two kinds of materials that can be used for the optical device.

FIG. 13 A view showing schematic views of a method of manufacturing the virtual image display apparatus according to the present technology.

FIG. 14 Graphs showing the transmittance and refractive index of optical devices of the virtual image display apparatus according to the present technology.

### MODE(S) FOR CARRYING OUT THE INVENTION

Hereinafter, a favorable embodiment of the present technology will be described. It should be noted that the embodiment shown below is an example of a representative embodiment of the present technology, and the present technology is not limited to the following favorable embodiment and can be freely modified within the scope of the present technology.

An optical device according to the present technology includes at least two or more types of light guide plates of a first light guide plate and a second light guide plate. The first light guide plate has a first light guide path formed of a first material. The second light guide plate has a second light guide path formed of a second material different from the first material.

There are no particular limitations as long as a light guide plate of the optical device according to the present technology includes a light guide path capable of propagating incident light. The light guide plate may include one or more optical components on the light guide path. The one or more optical components are capable of changing the travelling direction of light. The one or more optical components are, for example, diffraction gratings, reflective plates, or optical lenses.

A glass including an optical glass, e.g., a quartz glass and BK7, resin, and the like can be suitably used. In recent years, resin has been attracting attention as a material that forms the light guide path, due to its resistance to cracking and its cost advantages.

The resin that can form the light guide path is a material that is plastic among organic polymer compounds and can propagate incident light. Examples of the resin can include highly transparent resins such as a polycarbonate resin (PC), a cyclo-olefin resin (COP), an acrylic resin (PMMA), polyethylene terephthalate (PET), polyvinyl chloride (PVC), and polystyrene (PS).

The first material and the second material that can be used for the light guide paths of the optical device according to the present technology are different materials. The second material is higher in light transmittance than the first material. Regarding a highly transparent resin, the light transmittance of the material generally tends to become lower as the wavelength of light becomes shorter. Therefore, the second material favorably has a relatively high transmittance as compared to the first material for a wavelength of 493 nm or less corresponding to the upper limit wavelength of blue light with the shortest wavelength among RGB. The optical device according to the present technology uses two or more types of light guide plate having light guide paths formed of materials different in light transmittance, thereby being capable of propagating light with a shorter wavelength, which is easily absorbed by a light guide path of one light guide plate, through a light guide path of the other light guide plate. Therefore, it can be expected to output light while keeping the light amount balance between RGB of input image information. It should be noted that the optical device according to the present technology may be configured to include a plurality of light guide plates of one type selected from the above-mentioned two or more types of light guide plates.

Light that has entered the light guide path can be efficiently propagated especially by setting the transmittance for light with a wavelength of 435 nm corresponding to a lower limit wavelength of blue light of the second material to 85% or more, favorably to 90% or more, and more favorably to 95% or more.

In the present disclosure, red light, green light, and blue light represented as RGB refer to those including light with one or more wavelengths in each of the following ranges.
Red light: 620 to 780 nm
Green light: 492 to 577 nm
Blue light: 435 to 493 nm

Moreover, a display viewing angle of the see-through display depends on a refractive index of the materials that form the light guide paths. Therefore, the materials that form the light guide paths of the optical device according to the present technology are favorably materials with a higher refractive index. When the materials that form the light guide paths are materials with a higher refractive index, a large total reflection angle on an interface inside the light guide paths can be obtained in causing image information to enter the light guide paths. Thus, the image area that can be captured can be widened.

In the present disclosure, the display viewing angle has substantially the same meaning as a field-of-view angle. It represents an angle of a range where the contents of the display image can be correctly seen. It refers to an angle with which contrast ratio and color are similar to those as viewed from the front. Specifically, it can be calculated based on the size of a captured image obtained by capturing an output display image with a camera.

Regarding a highly transparent resin, the refractive index of the material generally tends to become lower as the wavelength of light becomes longer. Therefore, a decrease in refractive index for light with a longer wavelength can be suppressed by using two or more types of light guide plates having light guide paths formed of different materials as a configuration example of the optical device according to the present technology. It can also be expected to reduce a difference in refractive index between RGB as the entire optical device and increase the display viewing angle when it is used in the see-through display. Specifically, the first material is favorably higher than the second material in terms of a refractive index for light with a wavelength of 492 nm corresponding to a lower limit wavelength of green light with the shortest wavelength among RGB.

That is, the optical device according to the present technology more favorably uses two or more types of light guide plates, a light guide plate having a light guide path formed of a material excellent in transmittance for light with a shorter wavelength and a light guide plate having a light guide path formed of a material excellent in refractive index for a longer wavelength. Accordingly, in order to improve the propagation of light with a shorter wavelength and improve the refractive index of light with a longer wavelength, suppression of deterioration of light amount balance between RGB of an output display image with respect to input image information and enlargement of the display viewing angle can be both achieved.

Setting a refractive index of the first material for light with a wavelength of 492 nm corresponding to a lower limit of green light to 1.60 or more, favorably to 1.65 or more, and more favorably to 1.68 or more as the material excellent in refractive index for a longer wavelength can be expected to increase the display viewing angle also with respect to light with a longer wavelength.

Setting the refractive index of the second material for light with a wavelength of 493 nm corresponding to an upper limit of blue light to 1.58 or more, and favorably to 1.60 or more can be expected to increase the display viewing angle also with respect to light with a shorter wavelength.

The optical device according to the present technology may be configured to further include a third light guide plate having a third light guide path formed of a third material different from the first material and the second material in view of relationships between wavelength dispersion of the material and light transmittance or refractive index. Additionally, it may be configured to include a plurality of types of light guide plates having light guide paths formed of a material different from these materials. By providing an optimal light guide path corresponding to light of a wavelength to be propagated, deterioration of light amount balance between RGB can be more suitably suppressed or enlargement of the display viewing angle can be accomplished.

Hereinafter, the favorable embodiment of the present technology will be described in more detail with reference to the drawings.

### (1) Stack Configuration of Light Guide Plates

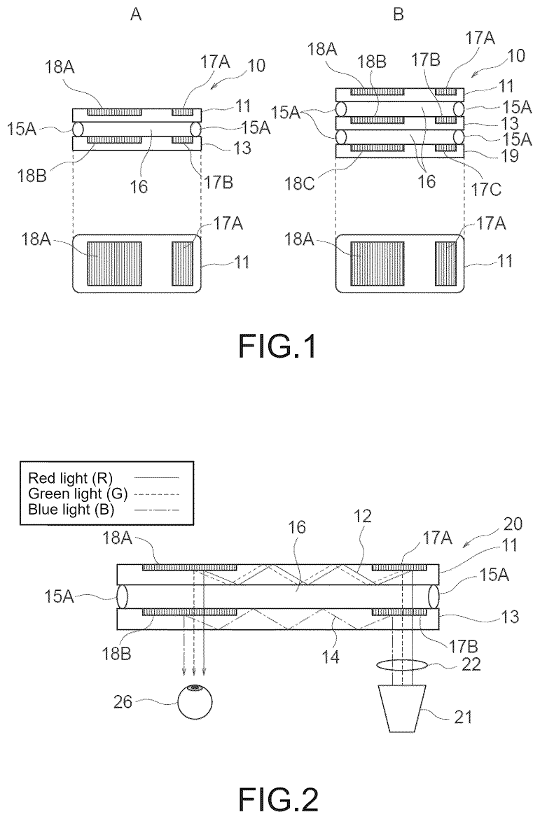

FIG. 1 is side cross-sectional views and plan views showing configuration examples of an optical device 10 according to the present technology. As shown in the figure of the side cross section, a first light guide plate 11 and a second light guide plate 13 that constitute the optical device 10 according to the present technology are superimposed on each other and are fixed. Moreover, also in a case where three or more types of light guide plates constitute the optical device according to the present technology, the light guide plates are superimposed on each other and are fixed.

In the optical device according to the present technology, the fixed light guide plates may be stacked in direct contact. However, when they are stacked via a medium 16 with a lower refractive index than materials that forms light guide paths, which are adhesive surfaces of the light guide plates, a difference in refractive index between the materials that form the light guide paths and the medium with a lower refractive index can be increased. Therefore, the critical angle of light propagating through the light guide paths at the light guide path interface decreases, and the angle band of light that can be guided increases. Thus, light that has entered the light guide paths can be efficiently propagated.

Examples of the medium with a lower refractive index can include the air, though not limited thereto. The thickness of the medium with a lower refractive index can be a thickness of about 100 μm, e.g., 50 μm to 200 μm, though not limited to this range.

The method of fixing the light guide plates to each other is not particularly limited as long as it can fix target light guide plates to each other. The light guide plates can be suitably fixed with an adhesive, for example.

In a case of fixing them with an adhesive, the adhesive to be used is not particularly limited as long as it can suitably adhere the materials (e.g., the first material and the second material) of the light guide paths, which are adhesive surfaces of the light guide plates, to each other.

The adhesive surfaces in a case of fixing them with an adhesive is not particularly limited as long as they are areas that can fix target light guide plates to each other. For example, a configuration in which by fixing end portions of the light guide plates with adhesives 15A as shown in FIG. 1, the light guide plates are stacked via an air layer 16, which is a medium with a lower refractive index than the materials that form the light guide paths, which are the adhesive surfaces of the light guide plates, due to the thickness of the adhesives 15A, can be provided.

### (2) Optical Component

As shown in A of FIG. 1, the optical device 10 according to the present technology includes an incident-side diffraction grating 17A serving as a first optical component arranged on an incident side of light associated with image information on the first light guide path and an output-side diffraction grating 18A serving as a second optical component arranged on an output side of the image information and includes an incident-side diffraction grating 17B serving as a third optical component arranged on an incident side of light associated with image information on the second light guide path and an output-side diffraction grating 18B serving as a fourth optical component arranged on an output side of the image information. Moreover, also in a case where three or more types of light guide plates constitute the optical device according to the present technology, optical components can be arranged on the incident side and the output side on the light guide path of each light guide plate.

B of FIG. 1 shows an example constituted by three types of light guide plates. In B of FIG. 1, a third light guide plate 19 includes an incident-side diffraction grating 17C serving as a fifth optical component arranged on an incident side of light associated with image information and an output-side diffraction grating 18C serving as a sixth optical component arranged on an output side of the image information.

As shown in the plan views in FIG. 1, the optical component on the output side of the image information is arranged to be wider than the optical component on the incident side of light associated with image information. In this way, input image information can be enlarged and output.

FIG. 2 is a schematic view showing a configuration example of the virtual image display apparatus 20 according to the present technology. FIG. 2 shows a state in which light output from an image forming section 21 enters a first light guide path 12 and a second light guide path 14 of the optical device 10 and information of the light reaches an observer's pupil 26.

In a case where the optical device according to the present technology includes two types of light guide plates, employing a design that the incident-side diffraction grating 17A serving as the first optical component arranged on the first light guide path 12 and the output-side diffraction grating 18A serving as the second optical component reflect light with a longer wavelength and the incident-side diffraction grating 17B serving as the third optical component arranged on the second light guide path 14 and the output-side diffraction grating 18B serving as the fourth optical component reflect light with a shorter wavelength can propagate light with a longer wavelength through the first light guide path and propagate light with a shorter wavelength through the second light guide path. Moreover, also in a case where three or more types of light guide plates constitute the optical device according to the present technology, arranging the optical components that reflect light with an optimal wavelength depending on characteristics of the materials that forms the light guide paths can propagate light with an optimal wavelength through each light guide path.

Examples of the light with a longer wavelength can include light with a wavelength of 492 nm or more corresponding to the lower limit of green light. Examples of the light with a shorter wavelength can include light with a wavelength of 493 nm or less corresponding to the upper limit of blue light.

The respective optical components described above are not limited to the diffraction gratings as long as they can change the travelling direction of light. For example, reflective plates, optical lenses, prisms, or the like can be suitably used. These optical components can be employed, machined into any shape such as a reflective type or transmissive type depending on a design of the optical device that propagates light.

In a case where diffraction gratings are used as the optical components on the light guide paths of the light guide plates, they can be integrally molded as the light guide plates by injection molding. Therefore, the diffraction gratings are favorable due to their manufacturing cost. Moreover, prisms can also be integrally molded with the light guide plates by injection molding as the optical components on the light guide paths of the light guide plates. In particular, in a case where prisms are used as the optical components on the incident surface side, in some cases, they can reduce the loss of light at the time of image information input to the light guide plates.

In a case where the optical device according to the present technology uses diffraction gratings as the optical components, the materials of the diffraction gratings can also be the same materials as the materials that form the light guide paths. The use of the same materials facilitates the manufacture of the light guide plates by injection molding. Therefore, it is favorable.

On the other hand, in a case where the diffraction gratings serving as the optical components are formed of materials different from the materials that form the light guide paths, one of the materials exemplified above as the materials that can form the light guide paths can be selected as appropriate for the materials. Moreover, the diffraction gratings formed of materials different from the materials that form the light guide paths can be suitably attached to the light guide plates by injection molding or imprinting technology.

In a case where the optical device according to the present technology uses diffraction gratings as the optical components, the shape of the diffraction gratings can also be single-axis type diffraction gratings having a periodic structure only in an X-axis direction or can also be two-axis type diffraction gratings having a periodic structure in the X-axis direction and a Y-axis direction.

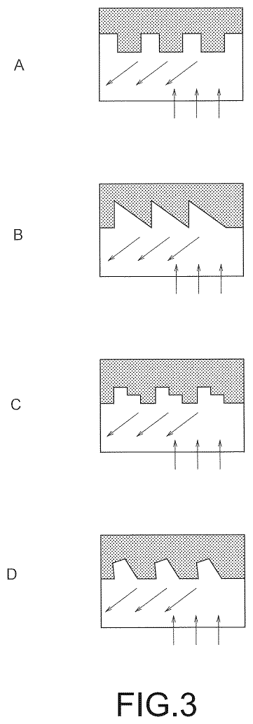

Examples of the shape of the diffraction grating can include the shapes shown in A to D of FIG. 3, though not limited thereto. The diffraction grating can be designed in any shape by a well-known method. In addition, although the diffraction grating can also be arranged along the light guide path as shown in FIG. 1 and the like, the diffraction grating can also be arranged, inclined obliquely to the light guide path. Adjusting the shape and arrangement of the diffraction grating can optimize the diffraction angle, the diffraction efficiency, and the like, and can selectively reflect or transmit light of a particular wavelength.

Regarding the diffraction grating of each of two or more types of light guide plates of the optical device according to the present technology, the diffraction angle, the diffraction efficiency, and the like can be designed, optimized in accordance with light with a target wavelength that is propagated by the light guide path of each light guide plate. Optimizing the diffraction grating in accordance with light with a target wavelength can also be expected to maximize the viewing angle of the display image to be output from each light guide plate.

Moreover, in the optical device according to the present technology, a color filter may be further arranged between the light guide plates. Accordingly, selectivity of the wavelength by the optical components such as the diffraction gratings can be expected to increase.

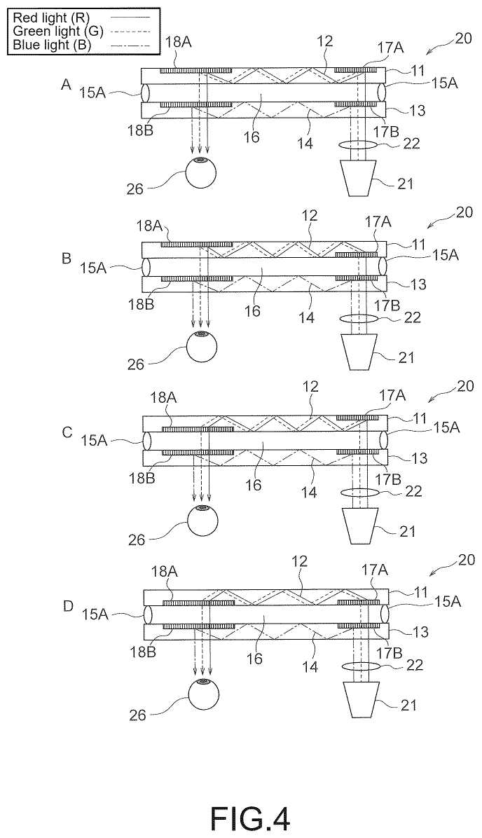

FIG. 4 is a schematic view showing arrangement examples of the optical components in the optical device according to the present technology. FIG. 4 shows usage examples in which reflective-type, transmissive-type optical components are arranged using the diffraction gratings as an example of the optical components. A configuration excluding the diffraction gratings serving as the optical components of the optical device shown in FIG. 4 is similar to the configuration of the virtual image display apparatus shown in FIG. 2.

The reflective-type or transmissive-type optical components can take four types of arrangements shown in A to D of FIG. 4 on the light guide paths of the light guide plates of the optical device according to the present technology as follows.

Regarding the first light guide plate 11 in the optical device 10 shown in A of FIG. 4, a reflective-type incident-side diffraction grating 17A and a reflective-type output-side diffraction grating 18A are arranged on the first light guide path 12.

Regarding the first light guide plate 11 in the optical device 10 shown in B of FIG. 4, a transmissive-type incident-side diffraction grating 17A and a reflective-type emitter-side diffraction grating 18A are arranged on the first light guide path 12.

Regarding the first light guide plate 11 in the optical device 10 shown in C of FIG. 4, a reflective-type incident-side diffraction grating 17A and a transmissive-type emitter-side diffraction grating 18A are arranged on the first light guide path 12.

Regarding the first light guide plate 11 in the optical device 10 shown in D of FIG. 4, a transmissive-type incident-side diffraction grating 17A and a transmissive-type emitter-side diffraction grating 18A are arranged on the first light guide path 12.

As shown in A to D of FIG. 4, it is favorable to arrange a transmissive-type diffraction grating on the side of an image information incident surface of the light guide path and arrange a reflective-type diffraction grating on a surface of the light guide path, which is located on a side opposite to the image information incident surface. Moreover, depositing a metal thin film on the surface of the light guide plate, which is located on the side opposite to the reflective-type diffraction grating, can also increase the reflectance and reduce the loss of light input.

It should be noted that although FIG. 4 shows the example of the four types of arrangements regarding the optical components arranged on the first light guide path by using the first light guide plate as an example, the second light guide plate can also take four types of arrangements for the optical components with respect to each of the four types of first light guide plates shown as the example of the arrangements in A to D of FIG. 4, as in the example of the first light guide plate. That is, in a case where the optical device according to the present technology includes two types of light guide plates, a configuration in which the four types of first light guide plates and the four types of second light guide plates are combined as appropriate can be employed. Moreover, also in a case where three or more types of light guide plates constitute the optical device according to the present technology, a configuration in which the four types of light guide plates are combined as appropriate can be employed.

### (3) Protective Substrate

Although the optical device according to the present technology may be disposable in a case where the optical components get dirt or are damaged, for example, a protective substrate for protecting the optical components may be provided. The provided protective substrate can protect the optical components such as the diffraction gratings arranged exposed to the outside from dirt or damage, for example, and can be expected to prolong the product lifetime of the optical device.

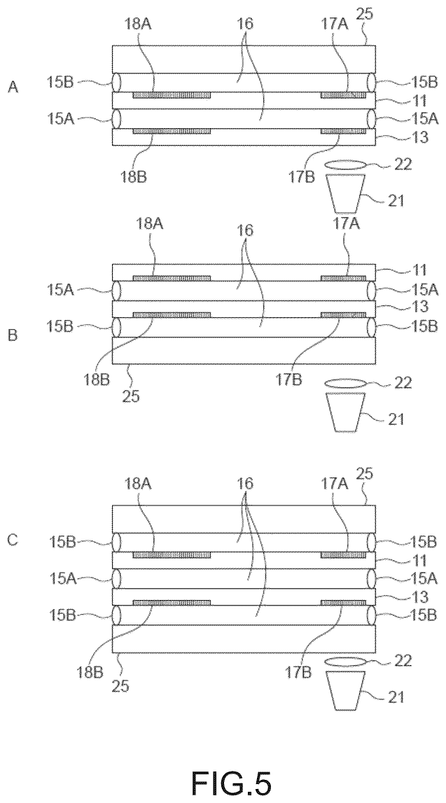

That is, in a case where reflective-type optical components are arranged on the outermost light guide path on an incident surface side of the optical device according to the present technology (the incident-side diffraction grating 17A and the output-side diffraction grating 18A are arranged on an outer surface side of the light guide path of the optical device), it is favorable to provide a protective substrate 25 on an output surface side of the optical device, which is a surface on a side opposite to a surface in contact with the light guide path, for protecting the optical components as shown in A of FIG. 5.

In a case where transmissive-type optical components are arranged on the light guide path arranged at the outermost position on an output surface side of the optical device according to the present technology (the incident-side diffraction grating 17B and the output-side diffraction grating 18B are arranged on the outer surface side of the light guide path of the optical device), it is favorable to provide a protective substrate 25 on an incident surface side of the optical device, which is a surface on a side opposite to a surface in contact with the light guide path, for protecting the optical components as shown in B of FIG. 5.

In a case where a transmissive-type optical component is arranged on the light guide path arranged at the outermost position on an incident surface side of the optical device according to the present technology and a reflective-type optical component is further arranged on the light guide path arranged at the outermost position on an output surface side, the optical components can be suitably protected by providing protective substrates 25 on both the incident surface side and the output surface side of the optical device, which are surfaces on a side opposite to a surface in contact with the light guide path, as shown in C of FIG. 5.

Although the protective substrate may be stacked in direct contact with the optical components, a difference in refractive index between the materials that form the light guide paths and the medium with a lower refractive index can be increased by stacking them via the medium with a lower refractive index than the materials that form the light guide paths on which the optical components are arranged. Therefore, the critical angle of light propagated through the light guide paths at the light guide path interface decreases, and the angle band of light that can be guided increases. Thus, light that has entered the light guide paths can be efficiently propagated.

Examples of the medium with a lower refractive index can include the air, though not limited thereto. A thickness of the medium with a lower refractive index can be a thickness of about 100 μm, e.g., 50 μm to 200 μm, though not limited to this range.

A method of fixing the protective substrate and the light guide plate to each other is not particularly limited as long as it can fix a target protective substrate and a target light guide plate to each other. For example, the protective substrate and the light guide plate can be suitably fixed with an adhesive or the like.

In a case of fixing them with an adhesive, the adhesive to be used is not particularly limited as long as it can suitably adhere the material of the protective substrate, which is an adhesive surface of the light guide plate, and the material of the light guide path to each other.

The adhesive surface in a case of fixing them with an adhesive is not particularly limited as long as it is an area that can fix a target protective substrate and a target light guide plate to each other. For example, as shown in FIG. 5, by fixing end portions of the light guide plate with adhesives 15B, a configuration in which they are stacked via the air layer 16 that is the medium with a lower refractive index than the materials that form the light guide paths, due to the thickness of the adhesives 15B, can be employed.

The material that forms the protective substrate is not particularly limited as long as a transmittance of the material for light with a wavelength of 435 nm is 90% or more. For example, a glass or a highly transparent resin can be suitably used. Examples of the highly transparent resin can include a polycarbonate resin (PC), a cyclo-olefin resin (COP), an acrylic resin (PMMA), polyethylene terephthalate (PET), polyvinyl chloride (PVC), and polystyrene (PS).

### (4) Virtual Image Display Apparatus

A virtual image display apparatus including the optical device according to the present technology includes an image forming section that outputs image light and an optical lens that converts the image light output from the image forming section into parallel light, and can be configured to cause the parallel light to enter the light guide plates of the optical device according to the present technology.

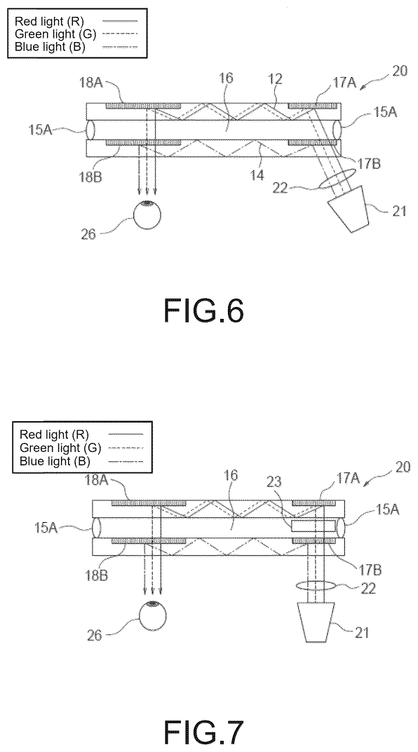

The virtual image display apparatus will be described in detail using FIGS. 2 and 6 showing schematic views of a configuration example and modified examples of the virtual image display apparatus according to the present technology.

The image forming section 21 is an apparatus that splits image light associated with image information into a plurality of color light beams and outputs them. The light source of the image forming section 21 may be a liquid crystal on silicon (LCOS) type, which has a lighting system even with self-illumination, or a high temperature poly-silicon (HTPS) type.

Alternatively, the light source of the image forming section 21 may be a digital light processing (DLP) type. In a case where the light source of the image forming section is self light emission, it may be light emitting diode (LED) light sources that are integral with a panel and are dispersed, may be a laser diode (LD) light source, or may be an organic electro-luminescence (EL) light source. Moreover, a configuration in which the image forming section is provided with a color filter may be employed.

The position where the image forming section 21 is arranged is not limited as long as it can cause image light to enter the first light guide plate 11 and the second light guide plate 13. For example, the image forming section 21 may be arranged to face the light guide plate as shown in FIG. 2. Alternatively, the image forming section 21 may be arranged, inclined obliquely to the light guide plate as shown in FIG. 6.

As shown in FIG. 2, in a case where the image forming section is arranged to face the light guide plate, the virtual image display apparatus can be easily designed to be compact with a smaller width, and the virtual image display apparatus can also be easily assembled due to its structure.

On the other hand, in a case where the image forming section is arranged, inclined obliquely to the light guide plate as shown in FIG. 6, light can enter at an angle at which total reflection of the light propagating through the light guide path on the light guide path interface is easily done while avoiding reflection on the surface of the light guide plate when the image light output from the image forming section enters the light guide plate. Therefore, for example, the optical components such as the diffraction gratings on the incident side can be expected to be easily designed.

An optical lens 22 is arranged between the image forming section 21 and the optical device 10 including the first light guide plate 11 and the second light guide plate 13. The optical lens 22 converts the image light output from the image forming section 21 into parallel light. The optical lens 22 is not particularly limited as long as it has the above-mentioned functions.

The optical lens 22 may be arranged to face the image forming section 21 as shown in FIG. 2 or 6. Alternatively, the optical lens 22 may be arranged, inclined obliquely to the image forming section 21.

The image light converted into parallel light by the optical lens 22 enters the optical device 10. Image light with a longer wavelength out of the entering image light propagates through the first light guide path 12 associated with the first light guide plate 11. Image light with a shorter wavelength propagates through the second light guide path 14 associated with the second light guide plate 13 and is output to the outside.

The virtual image display apparatus according to the present technology uses two or more types of light guide plates having the light guide paths formed of two different kinds of materials, thereby being capable of propagating light with a shorter wavelength, which is easily absorbed by a light guide path of one light guide plate, through a light guide path of the other light guide plate. Therefore, it can be expected to output light while keeping the light amount balance between RGB of input image information.

Moreover, the virtual image display apparatus according to the present technology uses two or more types of light guide plates having light guide paths formed of two different kinds of materials, thereby being capable of propagating light with a longer wavelength, whose refractive index easily decreases, through the light guide paths formed of the materials with a higher refractive index. Therefore, it can also be expected to reduce a difference in refractive index between the wavelengths of RGB and increase the display viewing angle when it is used in the see-through display.

That is, the virtual image display apparatus according to the present technology more favorably uses two or more types of light guide plates, a light guide plate having a light guide path formed of a material excellent in transmittance for light with a shorter wavelength and a light guide plate having a light guide path formed of a material excellent in refractive index for a longer wavelength. Accordingly, in order to improve the propagation of light with a shorter wavelength and improve the refractive index of light with a longer wavelength, suppression of deterioration of light amount balance between RGB of an output display image with respect to input image information and enlargement of the display viewing angle can be both achieved.

The arrangement of the first light guide plate 11 and the second light guide plate 13 with respect to the image forming section 21 are not limited. However, it is favorable to arrange the first light guide plate 11 on a side opposite to the image forming section 21 with respect to the second light guide plate 13. With this arrangement, the image light output from the image forming section 21 first enters the second light guide path 14 formed of the second material having a high transmittance for light with a shorter wavelength, and then enters the first light guide path 12 formed of the first material. Therefore, absorption of light with a shorter wavelength by the optical device 10 can be expected to be suppressed.

Moreover, also in a case where the virtual image display apparatus according to the present technology includes the optical device constituted by three or more types of light guide plates, the light guide plate having a light guide path formed of a material having the highest transmittance for light with a shorter wavelength is arranged on a side closer to the image forming section. Thereafter, the light guide plates are arranged in the order of the transmittance of materials that form the light guide paths for light with a shorter wavelength. This arrangement can minimize absorption of light with a shorter wavelength by the optical device.

In the optical device 10 of the virtual image display apparatus 20 according to the present technology, a color filter may be further arranged between the light guide plate and the light guide plate. Accordingly, selectivity of the wavelength by the optical components such as the diffraction gratings can be expected to increase. By arranging a color filter 23 between the incident-side diffraction grating 17A having the first light guide plate 11 and the incident-side diffraction grating 17B having the second light guide plate 13 as shown in the modified example of the virtual image display apparatus in FIG. 7, green light and red light, which are light with a target wavelength, can enter the first light guide plate 11. The output-side diffraction grating 18A provided on the first light guide path 12 is designed to have an output angle of light in accordance with the wavelengths of green light and red light. Therefore, it can be expected to prevent blue light from being mixed in light output from the first light guide path 12 and to prevent the display image output from the optical device 10 from flickering.

Also in a case where the virtual image display apparatus according to the present technology includes the optical device of light guide plates constituted by three or more types, a color filter is further arranged between the light guide plates. In this way, light with a target wavelength can enter each light guide plate of the virtual image display apparatus.

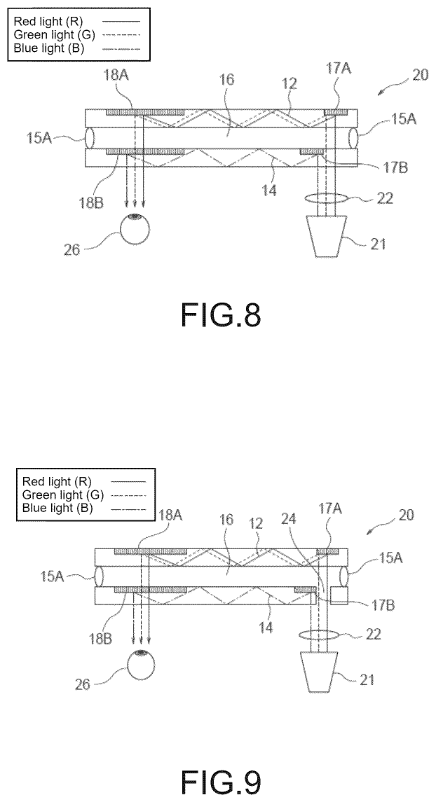

Additionally, in the optical device 10 of the virtual image display apparatus 20 according to the present technology, the area of the optical components on the incident side of the light guide plate arranged on the side of the image forming section may be designed to be a narrower area with respect to the entire incident area of parallel light that is output from the image forming section and is converted by the optical lens. Accordingly, excessive light with wavelengths other than a target can be prevented from entering the light guide plate arranged on the side of the image forming section. As shown in the modified example of the virtual image display apparatus in FIG. 8, the incident-side diffraction grating 17B of the second light guide plate 13 arranged on the side of the image forming section 21 is narrower with respect to the area of incident light. Therefore, green light and red light, which are light with a target wavelength, can enter the first light guide plate 11. Therefore, it can be expected to reduce attenuation of the entire image light constituted by blue light, green light, and red light that has entered the light guide plate.

Also in a case where the virtual image display apparatus according to the present technology includes the optical device of light guide plates constituted by three or more types, the contact area of the optical components on the incident side of each light guide plate is adjusted. In this way, light with a target wavelength can enter each light guide plate of the virtual image display apparatus.

Additionally, the optical device 10 of the virtual image display apparatus 20 according to the present technology may include a hole in the light guide plate arranged on the side of the image forming section. The hole is for causing parallel light, which has been output from the image forming section and has been converted by the optical lens, to directly enter the light guide plate arranged on a side away from the image forming section. Accordingly, light with a target wavelength can directly enter the light guide plate arranged on the side away from the image forming section. Therefore, the loss of light when the light passes through the light guide plate can be avoided. As shown in the modified example of the virtual image display apparatus in FIG. 9, a hole 24 is provided at a position of the second light guide plate 13 arranged on the side of the image forming section 21, that light from the image forming section 21 enters. Therefore, green light and red light, which are light with a target wavelength, can directly enter the first light guide plate 11 without passing through the second light guide plate 13.

Also in a case where the virtual image display apparatus according to the present technology includes the optical device of light guide plates constituted by three or more types, the position and size of the hole in each light guide plate is adjusted. In this way, light with a target wavelength can efficiently enter each light guide plate of the virtual image display apparatus.

The virtual image display apparatus including the optical device according to the present technology can be widely used for general applications of the see-through display (also referred to as transmissive-type display, transparent display). The see-through display refers to a display through which the back of a screen to which the image information is output is visible. Examples of the see-through display can include a head-mounted display and a show window.

### (5) Head-Mounted Display

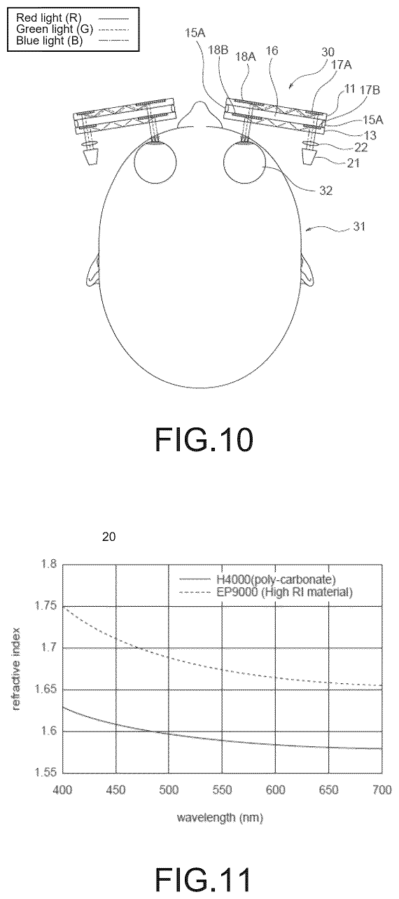

A usage example of a head-mounted display will be described as an example of applications of the virtual image display apparatus according to the present technology as a see-through display, using a conceptual diagram showing a mounting example of a head-mounted display 30 in FIG. 10. It should be noted that the applications of the virtual image display apparatus according to the present technology are not limited to the head-mounted display shown here.

As shown in the conceptual diagram of FIG. 10, the image light output from the image forming section 21 is converted into parallel light by the optical lens 22. Then, the image light enters the first light guide path 12 of the first light guide plate 11 and the second light guide path 14 of the second light guide plate 13. The image light propagates through each light guide path. The image light is output from the virtual image display apparatus 20 as the image information. In this way, the image light is recognized as a virtual image by a pupil 32 of an observer 31.

As described above, the first light guide path 12 and the second light guide path 14 are formed of a highly transparent resin. Therefore, the observer 31 wearing the head-mounted display 30 according to the present technology is capable of visually recognizing the back side of the image information output from the light guide path of the light guide plate. Accordingly, for example, the head-mounted display according to the present technology can also be expected to realize augmented reality (AR).

It should be noted that although FIG. 10 shows a head-mounted display including two virtual image display apparatuses for right and left eyes, a head-mounted display including one virtual image display apparatus for one eye can be employed. Moreover, in a case where the head-mounted display includes two virtual image display apparatuses, the virtual image display apparatuses for right and left eyes may display the same image or may display different images (e.g., images that can display a three-dimensionally image).

### EXAMPLES

Hereinafter, the present technology will be more specifically described using an example. It should be noted that the present technology is not limited to the contents of the example shown below.

### <Raw Materials of Light Guide Plates>

Resin A: thermoplastic polycarbonate EP9000 (manufactured by Mitsubishi Gas Chemical Company, Inc.)
Resin B: thermoplastic polycarbonate H4000 (manufactured by Mitsubishi Gas Chemical Company, Inc.)

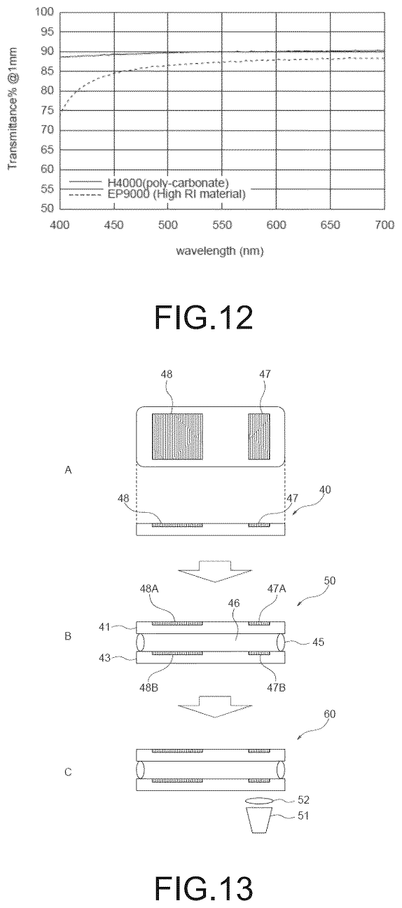

FIG. 11 is a graph showing relationships between the refractive index and the wavelength dispersion of EP9000 and H4000. FIG. 12 is a graph showing relationships between the light transmittance and the wavelength dispersion of EP9000 and H4000.

As shown in the graph in FIG. 11, it can be confirmed that EP9000 exhibits a relatively high refractive index with respect to H4000 while H4000 exhibits a refractive index of 1.60 or more with respect to light with a wavelength of 493 nm or less corresponding to the upper limit wavelength of blue light.

As shown in the graph in FIG. 12, H4000 exhibits a relatively high light transmittance with respect to EP9000. In particular, regarding light with a wavelength of 493 nm or less corresponding to the upper limit wavelength of blue light, it can be confirmed to exhibit a relatively high transmittance.

### <Manufacture of Virtual Image Display Apparatus>

A method of manufacturing the virtual image display apparatus will be described using FIG. 13 showing a schematic view of the method of manufacturing the virtual image display apparatus.

Using each of the resins H4000 and EP9000, a light guide plate in a plate shape including the area of two diffraction gratings (an incident-side diffraction grating 47 and an output-side diffraction grating 48) on one surface of the plate was fabricated by injection molding as shown in A of FIG. 13.

A design was made such that a light guide plate 40 had a plate thickness of 1 mm and the incident-side diffraction grating 47 and the output-side diffraction grating 48 were binary diffraction gratings as shown in A of FIG. 3 with a period of 400 nm, with a width of a convex of the convexo-concave portion of 200 nm, and a depth of 100 nm.

Using a first light guide plate 41 formed of EP9000 and a second light guide plate 43 formed of H4000 out of the light guide plates 40 molded in substantially the same shape as the above-mentioned design, three types of optical devices 50 according to Example 1, Comparative Example 1, and Comparative Example 2 was manufactured as combinations as follows.

### Example 1 (First Light Guide Plate, Second Light Guide Plate)

### Comparative Example 1 (First Light Guide Plate, First Light Guide Plate)

### Comparative Example 2 (Second Light Guide Plate, Second Light Guide Plate)

The light guide plates according to each of the combination are superimposed on each other as shown in B of FIG. 13 and their circumferential portions were fixed with UV curable adhesives 45 (PET base material tape/Nitto Denko Corporation).

In each of the three types of optical devices 50 according to the combinations, the light guide plates were stacked via an air layer 46 due to the thickness of the UV curable adhesives 45. The thickness of the air layer 46 was about 100 μm.

By fixing a projector having a LCOS display 51 corresponding to the image forming section and an optical lens 52 with respect to each of the three types of optical devices 50 as shown in C of FIG. 13, modules associated with three types of virtual image display apparatuses 60 were completed.

### <Assessment of Virtual Image Display Apparatus>

Table 1 shows assessment results of the three types of virtual image display apparatuses.

TABLE 1

| | Transmittance | Refractive | Display viewing |
|---|---|---|---|
| | (%) | index | angle (deg.) |
| Example 1 | >85% | 1.61-1.67 | 14-18 |
| Comparative Example 1 | 80% | 1.65-1.71 | 17-19 |
| Comparative Example 2 | >85% | 1.57-1.61 | 12-15 |

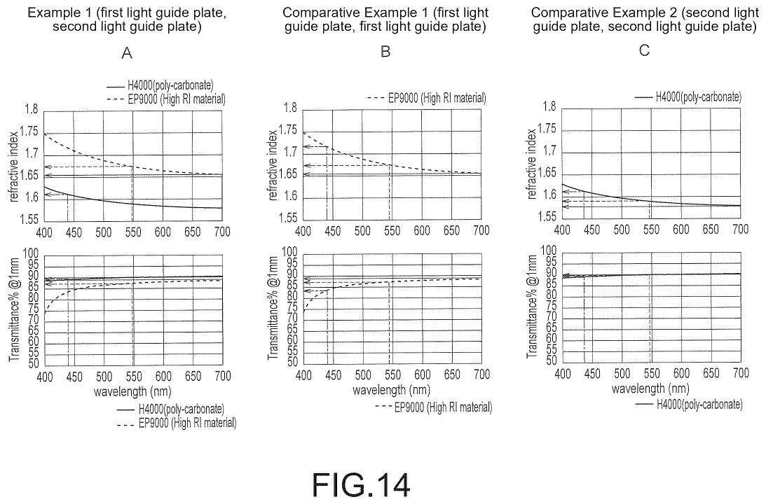

In Table 1, regarding the transmittance, the transmittance of light with the lowest transmittance among the RGB light was set as a transmittance of the optical device of the virtual image display apparatus, using the graph showing relationships between the light transmittance and the wavelength dispersion shown in FIG. 14. In the virtual image display apparatus according to the example, it is the transmittance of green light as shown in A of FIG. 14. In the virtual image display apparatus according to Comparative Example 1, it is the transmittance of blue light as shown in B of FIG. 14. In the virtual image display apparatus according to Comparative Example 2, it is the transmittance of blue light as shown in C of FIG. 14.

In Table 1, the refractive index was calculated by a critical angle method. In this assessment, the wavelength of blue light used is 450 nm, the wavelength of green light is 532 nm, and the wavelength of red light is 650 nm.

FIG. 14 is a graph drawing the relationships between the refractive index and the wavelength dispersion in accordance with Cauchy's dispersion formula on the basis of data on the refractive index described above.

In Table 1, the display viewing angle was calculated on the basis of the size of a captured image obtained by capturing a display image output from each virtual image display apparatus with a camera.

It was confirmed that the virtual image display apparatus according to Example 1 can efficiently propagate blue light, which is light with a shorter wavelength, on the light guide path in the same way as other light. Therefore, the light amount balance between RGB can be easily maintained. Further, a decrease in refractive index of red light, which is light with a longer wavelength, was also suppressed. Therefore, the display viewing angle when it is used in the see-through display was able to be increased.

The virtual image display apparatus according to Comparative Example 1 had a transmittance of 80% for blue light, the light amount balance with respect to the other light deteriorated, and the output display image appeared more yellow.

The virtual image display apparatus according to Comparative Example 2, blue light, which is light with a shorter wavelength, was also able to be efficiently propagated on the light guide path in the same way as other light. However, the refractive index was lower. Therefore, the display viewing angle was narrower.

It should be noted that the present technology can take the following configurations.
(1) An optical device, including:
   a first light guide plate having a first light guide path formed of a first material; and
   a second light guide plate having a second light guide path formed of a second material different from the first material, in which
   the second material has a higher transmittance for light with a wavelength of 493 nm or less than the first material.
(2) An optical device, including:
   a first light guide plate having a first light guide path formed of a first material; and
   a second light guide plate having a second light guide path formed of a second material different from the first material, in which
   the first material has a higher refractive index for light with a wavelength of 492 nm than the second material.
(3) The optical device according to (1) or (2), in which
   a transmittance of the second material for light with a wavelength of 435 nm is 85% or more.
(4) The optical device according to any one of (1) to (3), in which
   a refractive index of the first material for light with a wavelength of 492 nm is 1.6 or more.
(5) The optical device according to any one of (1) to (4), in which
   a refractive index of the second material for light with a wavelength of 493 nm is 1.6 or more.
(6) The optical device according to any one of (1) to (5), in which
   the first light guide plate and the second light guide plate are stacked via a medium with a lower refractive index than the first material and the second material.
(7) The optical device according to any one of (1) to (6), further including
   a third light guide plate having a third light guide path formed of a third material different from the first material and the second material.
(8) The optical device according to any one of (1) to (7), in which
   the first material and the second material are resins.
(9) The optical device according to any one of (1) to (8), in which
   the first light guide plate includes a first optical component and a second optical component on the first light guide path, and
   the second light guide plate includes a third optical component and a fourth optical component on the second light guide path.
(10) The optical device according to any one of (1) to (9), in which
   the first optical component and the second optical component reflect light with a wavelength of 492 nm or more, and
   the third optical component and the fourth optical component reflect light with a wavelength of 493 nm or less.
(11) The optical device according to (9) or (10), in which
   the optical components are diffraction gratings.
(12) The optical device according to any one of (9) to (11), in which
   any of the optical components is arranged on an outer surface side of any of the light guide paths and includes a protective substrate on a surface of the optical component, the surface being located on a side opposite to a surface that is held in contact with the light guide paths, the protective substrate having a transmittance for light with a wavelength of 435 nm is 90% or more.
(13) The optical device according to (12), in which
   the first light guide plate and the protection substrate are stacked via a medium with a lower refractive index than the first material and the second material.
(14) A virtual image display apparatus, including:
   an image forming section that outputs image light;
   an optical lens that converts the image light output from the image forming section into parallel light; and
   the optical device according to any one of (1) to (13) that causes the parallel light to enter the first light guide plate and the second light guide plate.
(15) The virtual image display apparatus according to (14), in which
   the first light guide plate is arranged on the second light guide plate on a side opposite to the image forming section.
(16) A head-mounted display, including
   a virtual image display apparatus according to (14) or (15).

### REFERENCE SIGNS LIST

10 optical device
11 first light guide plate
12 first light guide path
13 second light guide plate
14 second light guide path
15A, 15B adhesive
16 medium with low refractive index (air layer)
17A first optical component (incident-side diffraction grating)
18A second optical component (output-side diffraction grating)
17B third optical component (incident-side diffraction grating)
18B fourth optical component (output-side diffraction grating)
17C fifth optical component (incident-side diffraction grating)
18C sixth optical component (output-side diffraction grating)
19 third light guide plate
20 virtual image display apparatus
21 image forming section
22 optical lens
23 color filter
24 hole
25 protective substrate
26 observer's pupil
30 head-mounted display
31 observer
32 observer's pupil
40 light guide plate
41 first light guide plate
43 second light guide plate
45 UV curable adhesive
46 air layer
47, 47A, 47B incident-side diffraction grating
48, 48A, 48B output-side diffraction grating
50 optical device
51 LCOS display
52 optical lens
60 virtual image display apparatus

What is claimed is:

1. An optical device, comprising:
a first light guide plate having a first light guide path formed of a first material; and
a second light guide plate having a second light guide path formed of a second material different from the first material, wherein
the second material has a higher transmittance for light with a wavelength of 493 nm or less than the first material.

2. The optical device according to claim 1, wherein
a transmittance of the second material for light with a wavelength of 435 nm is 85% or more.

3. The optical device according to claim 1, wherein
a refractive index of the first material for light with a wavelength of 492 nm is 1.6 or more.

4. The optical device according to claim 1, wherein
a refractive index of the second material for light with a wavelength of 493 nm is 1.6 or more.

5. The optical device according to claim 1, wherein
the first light guide plate and the second light guide plate are stacked via a medium with a lower refractive index than the first material and the second material.

6. The optical device according to claim 1, further comprising
a third light guide plate having a third light guide path formed of a third material different from the first material and the second material.

7. The optical device according to claim 1, wherein
the first material and the second material are resins.

8. The optical device according to claim 1, wherein
the first light guide plate includes a first optical component and a second optical component on the first light guide path, and
the second light guide plate includes a third optical component and a fourth optical component on the second light guide path.

9. The optical device according to claim 8, wherein
the first optical component and the second optical component reflect light with a wavelength of 492 nm or more, and
the third optical component and the fourth optical component reflect light with a wavelength of 493 nm or less.

10. The optical device according to claim 8, wherein
the optical components are diffraction gratings.

11. The optical device according to claim 8, wherein
any of the optical components is arranged on an outer surface side of any of the light guide paths and includes a protective substrate on a surface of the optical component, the surface being located on a side opposite to a surface that is held in contact with the light guide paths, the protective substrate having a transmittance for light with a wavelength of 435 nm is 90% or more.

12. The optical device according to claim 11, wherein
the first light guide plate and the protection substrate are stacked via a medium with a lower refractive index than the first material and the second material.

13. A virtual image display apparatus, comprising:
an image forming section that outputs image light;
an optical lens that converts the image light output from the image forming section into parallel light; and
the optical device according to claim 1 that causes the parallel light to enter the first light guide plate and the second light guide plate.

14. The virtual image display apparatus according to claim 13, wherein
the first light guide plate is arranged on the second light guide plate on a side opposite to the image forming section.

15. A head-mounted display, comprising
a virtual image display apparatus according to claim 13.
